(19) United States
(12) Patent Application Publication
(10) Pub. No.: US 2005/0154894 A1
(43) Pub. Date: Jul. 14, 2005

(54) Access protection

(75) Inventor: Reinhold Freudenschuss, Augsburg (DE)

Correspondence Address: COHEN, PONTANI, LIEBERMAN & PAVANE, 551 FIFTH AVENUE, SUITE 1210, NEW YORK, NY, 10176, US

(73) Assignee: FUJITSU SIEMENS COMPUTERS GMBH, MUNICH (DE)

(21) Appl. No.: 10/507,529

(22) PCT Filed: Jan. 14, 2003
(86) PCT No.: PCT/DE03/00092

(30) Foreign Application Priority Data
Mar. 13, 2002 (DE) 102 11 036.0

(51) Int. Cl. H04K 1/00

(52) U.S. Cl. 713/182

(57) ABSTRACT

An access protection system for a computer, the invention taking which takes advantage of the fact that every transportable storage medium has an individual identifier. This individual identifier is used as an access key for the computer instead of a password.

The invention relates to an access protection system for a computer.

It has been known practice to date to use the input of a password as an access protection system for a computer. The password may either be input as a BIOS password, so that the computer boots up only after the password has been input, or for the purpose of authenticating operating system applications, so that although the computer is in operation the application is accessed only by inputting a password.

As an alternative to inputting a password, it is known practice to use a fingerprint sensor or chip card as access protection system. A chip card is drawn like a key through an appropriate card reader, for example in the keyboard, in order to obtain access to the computer or PC. A fingerprint sensor may be in the mouse or else on the keyboard or else connected separately to the computer, and only those people whose fingerprints are recorded in the computer gain access to the computer.

Passwords have the drawback that they are frequently forgotten and for security reasons new passwords need to be used every three to four months normally. The result of this is that most users use trivial passwords. In addition, passwords are usually not handled especially confidentially, which means that only limited protection is achieved.

In this regard, the chip card reader is a further development, but access to the computer is problematical if the chip card is lost, and an additional device in the form of the chip card and the chip card reader is required on the computer.

The fingerprint sensor is likewise a further development over password input, but requires the sensor on the mouse, on the keyboard or on the special supplementary unit, and the access code cannot be passed on as in the case of the password or the chip card.

The invention is therefore based on the object of demonstrating a simple access protection system for computers which avoids the input of a password.

The invention achieves this object by virtue of access being enabled by connecting a registered transportable storage medium to the computer.

The transportable storage medium may be a transportable mass memory or else a compact Flash memory.

A known Flash memory is the Memory Bird product from the applicant Fujitsu Siemens Computers GmbH, for example, which can be connected to the computer directly using a universal serial bus connection or can be connected to the computer using a USB connection on the keyboard or monitor.

Similarly, it is also possible to use any other non-volatile storage media, for example the commercially available products Compact Flash, Memory Stick, Multimedia card and so forth. It is merely necessary for the computer to have an available contact device for these components. In the case of Notebooks and PDAs (Personal Digital Assistants), this is normally the case for the Compact Flash.

The applicant's known Flash memory called Memory Bird is a compact transportable storage medium containing approximately 32 to 128 MB, which is intended for the end user. This product has an individual serial number which is defined in hardwired form and in a manner linked to the hardware in the product.

Similarly, it is naturally also possible to use products with a serial number written in software in the Flash memory.

The invention takes advantage of the fact that all transportable storage media have an individual serial number or an individual identifier which can be stored in the computer. When a transportable storage medium is now connected to the computer, the computer attempts, provided that it was turned off, to recognize the storage medium connected to the interface during the boot process (plug and play), and by adjusting whether or not the serial number or the individual identifier is stored it is possible to stop the boot process or, if the serial number or the identifier is stored, the boot process is continued and hence access to the computer is permitted.

Similarly, it is also possible to gain access to particular applications during operation of a computer.

If the transportable storage medium, such as the Memory Bird, has hotplug capability, that is to say that it can be connected while the computer is running, then the computer checks the individual identifier, such as the serial number, to determine whether it is registered in this computer, and then enables access either to all applications or to particular applications.

The invention thus takes advantage of the fact that a transportable storage medium is used simultaneously as an individual access key for a PC. This allows a pin or the input of a password to be dispensed with. This significantly simplifies access for an end user, and also a dual use is obtained for the transportable mass memory, since it is being used as an access key at the same time. A transportable mass memory, such as a Flash memory, may be used as key fob and on most computers may be conveniently plugged onto the keyboard or the screen using a USB connection.

Similarly, it is naturally also possible to use any other interfaces to the computer, such as parallel or serial interfaces, for connecting a transportable mass memory which is used simultaneously as an access key for the PC, provided that the computer requests the individual identifier for the transportable mass memory at these interfaces.

1-5. (canceled)

6. A method for providing access to a computer by an access protection system, comprising:
connecting to the computer a transportable storage medium which electronically stores an individual identifier; and
enabling access only if the computer recognizes said individual identifier.

7. The access protection system as claimed in claim 6, wherein the computer comprises a CPU, a monitor, a keyboard and at least one peripheral device, and a USB (Universal Serial Bus) interface connects the transportable storage medium to one of the CPU, the monitor, the keyboard and the at least one peripheral device.

8. The access protection system as claimed in claim 6, wherein said individual identifier is the serial number of the transportable storage medium.

9. The access protection system as claimed in claim 6, wherein said individual identifier is stored in the computer.

10. The access protection system as claimed in claim 6, wherein said individual identifier enables access to all applications in the computer.

11. The access protection system as claimed in claim 6, wherein said individual identifier enables access to at least one pre-designated application in the computer.

12. The access protection system as claimed in claim 6, wherein the transportable storage medium is a Flash memory or a storage medium which is technically similar.

13. A transportable storage medium with an individual identifier, wherein the transportable storage medium is used as an individual access key for a computer.
